(19) United States
(12) Patent Application Publication
(10) Pub. No.: US 2013/0146512 A1
(43) Pub. Date: Jun. 13, 2013

(54) ORIENTING DEVICE/APPARATUS AND ORIENTING METHOD

(71) Applicants: Nicholas Reynolds, Kings Lynn (GB); Sean Brennan, London (GB)

(72) Inventors: Nicholas Reynolds, Kings Lynn (GB); Sean Brennan, London (GB)

(21) Appl. No.: 13/640,897

(22) PCT Filed: Apr. 12, 2011
(86) PCT No.: PCT/GB2011/000582

§ 371 Date: Feb. 25, 2013

(30) Foreign Application Priority Data
Apr. 12, 2010 (GB) 1006064.8

(51) Int. Cl. B65G 47/14; B07C 5/342; B07C 5/10; B65G 47/24; B07C 5/02

(52) U.S. Cl. CPC B65G 47/14; B65G 47/24; B07C 5/02; B07C 5/10; B07C 5/3422
USPC 209/539; 198/383

(57) ABSTRACT

An orienting device for receiving a bulk flow of unshelled pistachio nuts and aligning and orienting them to provide single flows of nuts having a desired, common orient, the device comprises: an orienting section (27) comprising a plurality of tracks (25), which receive a flow of nuts from an infeed section, and align and orient the nuts, each track (25) comprising an orienting part (29), which comprises a base and first and second lateral orienting guides (39) makes the nuts rotate. The tray is a vibrating tray.

The present invention relates to an orienting device and apparatus for orienting objects, in particular unshelled nuts, and especially pistachio nuts, a sorting system incorporating the orienting device for sorting such objects, and methods of orienting and sorting objects, in particular unshelled nuts, and especially pistachio nuts.

Unshelled nuts, especially pistachio nuts, are particularly difficult to sort, where sorting is required based on whether the shell is open or closed. It is necessary to remove closed-shell pistachio nuts, as, in most uses, open-shelled pistachio nuts are required, for example, to enable roasting, flavoring and coloring, and also to enable easy removal of the shell for eating, with a majority of pistachio nuts being sold in packs as edible snacks.

For over thirty years, pistachio nuts have been sorted using pin sorters, which comprise a large drum having pins on its inner surface, through which is delivered a flow of pistachio nuts, with the pins acting to catch in the splits of open shells and carry the caught nuts to the top of the drum where the nuts are removed by brushes and collected. These drums are typically about 10 m in length and 2 to 3 m in diameter, and typically several pin sorters are arranged in series, such that the nuts which pass from the drum of one sorter are passed to the next sorter.

These existing pin sorters have a number of disadvantages. Significantly, these pin sorters are not very efficient and can only achieve efficiencies of about 75%, even when several sorters are arranged in series. Also, these pin sorters are very expensive, both in terms of capital outlay and in running costs, in terms of power consumption and through requiring regular replacement of the sorting drum liners. In addition, through their size, the existing pin sorters require a large facility. Furthermore, the existing pin sorters, through the mechanical action of the pins penetrating the splits, are prone to damage the flesh of the nuts, which can give the undesirable appearance of worm holes.

It is thus an aim of the present invention to provide an improved sorting apparatus and method for sorting, in particular pistachio nuts, and especially a sorting apparatus which has an improved sorting efficiency and has a much smaller footprint as compared to existing sorters.

In one aspect the present invention provides an orienting device for receiving a bulk flow of objects and aligning and orienting the objects to provide single flows of objects having a desired, common orient, the device comprising: an infeed section to which a flow of objects is delivered; and an orienting section in which the objects are provided in a plurality of separate flows and with the desired orient; wherein the orienting section comprises a plurality of tracks, which receive a flow of objects from the infeed section, and align and orient the objects as individual flows of oriented objects, each track comprising an orienting part, which comprises a base and first and second lateral orienting guides which act to confer a rotational moment to each object passing therealong and rotate the object to present the object in the desired orient.

In one embodiment the orienting section further comprises an alignment part, upstream of the orienting part, which acts to achieve a single flow of objects.

In one embodiment each track in the alignment part comprises a base, which supports the objects passing therethrough, and first and second lateral alignment guides which act to move the objects laterally to a common track axis as the objects move along the alignment part, and thereby provide a single flow of objects, one following the other.

In one embodiment the alignment guides define a progressively narrowing path, preferably tapering inwardly, which narrows along a length thereof in the flow direction, such that a single object is passed from the alignment part to the orienting part.

In one embodiment the orienting guides have a spacing which progressively narrows, preferably tapering inwardly, in the flow direction, and each orienting guide presents a downwardly-facing surface, under which an edge region of an object is located when moved along a length of the orienting part, such that, when an edge of an object becomes located under one of the orienting guides as the object is moved therealong, the other of the orienting guides, by virtue of the narrowing spacing between the orienting guides, engages an opposite edge of the object to the one edge, applying a lifting force to the opposite edge of the object and imparting a rotational moment to the object, causing the object to be oriented in the desired orient.

In one embodiment the orienting guides are inclined downwardly relative to the base along a length thereof in the flow direction, such that the spacing between the downwardly-facing surfaces of the orienting guides and the base decreases progressively, thereby guiding the one edge of the object beneath the respective orienting guide and promoting rotation of an object as the object moves along the orienting part.

In one embodiment the orienting guides have at least an arcuate lower surface, and preferably a complete or near-complete arcuate section.

In one embodiment the orienting guides are each provided by a side wall, preferably a vertical sidewall, and a bead element projecting inwardly therefrom.

In one embodiment the bead element comprises a part-cylindrical element, preferably a hemi-cylindrical element, and preferably the bead element has a radius of about 1.5 mm.

In one embodiment the orienting guides at the outlet end of the orienting part have a height above the base of orienting part which provides for the object to engage the base of the orienting part thereat.

In one embodiment the orienting section further comprises a transfer part, downstream of the orienting part, which acts to transfer the aligned and oriented flows of objects from the orienting part.

In one embodiment each track in the transfer part comprises first and second lateral transfer guides, which act to guide the flow of oriented objects from the orienting part in the desired orient.

In one embodiment each track in the transfer part further comprises a base which includes at least one aperture therein, which allows any object parts which may become detached to fall from the orienting device.

In one embodiment the transfer guides are inclined upwardly along a length thereof in the flow direction, such that the spacing between the transfer guides and the base increases progressively in height, thereby raising each transferred object clear of the base and providing that the transferred object is supported only by the transfer guides.

In one embodiment the transfer guides have at least an arcuate upper surface, and preferably a complete or near-complete arcuate section.

In one embodiment the transfer guides are each provided by a side wall, preferably a vertical sidewall, and a bead element projecting inwardly therefrom.

In one embodiment the bead element comprises a part-cylindrical element, preferably a hemi-cylindrical element, and preferably the bead element has a radius of about 1.5 mm.

In one embodiment the device further comprises: an outfeed section, downstream of the orienting section, from which the aligned and oriented flows from the orienting section are delivered.

In one embodiment an upstream end of the orienting device is raised slightly relative to a downstream end of the orienting device, whereby a vibration action is sufficient to cause objects to flow along and through the orienting device.

In one embodiment the device is provided in the form of a tray.

In one embodiment the objects are unshelled nuts, preferably pistachio nuts, and the desired orient is the orient of a split in the shell, if present.

In another aspect the present invention provides an orienting apparatus for receiving objects in bulk and aligning and orienting the objects to provide single flows of objects having a desired, common orient, the apparatus comprising: an orienting unit comprising the above-described orienting device; and a feed unit for feeding objects to the orienting unit.

In one embodiment the feed unit comprises a feed device which is connected to an upstream end of the orienting device to provide a flow of objects to the orienting device, the feed device comprising a receiving part beneath an outlet, and a ramp part, preferably an arcuate ramp part, which connects the receiving part to the upstream end of the orienting device.

In one embodiment the ramp part has a progressively-decreasing radius in the flow direction, and acts to accelerate movement of object from the receiving part to the infeed section of the orienting device, thereby spacing the objects delivered to the infeed section of the orienting device.

In one embodiment the apparatus further comprises: a vibration unit which is operative to vibrate the feed device of the feed unit and the orienting device of the orienting unit, such as to impart a vibration on objects when supported thereon and transfer the same along and through the orienting device.

In a further aspect the present invention provides a sorting system for sorting objects, comprising: the above-described orienting apparatus; and a separation unit for imaging the flows of objects delivered from the orienting device, preferably both for shape and color, and separating identified objects.

In one embodiment the objects are unshelled nuts, preferably pistachio nuts, and the identified objects are objects which have a closed shell.

In a still further aspect the present invention provides a method of aligning and orienting objects from a bulk flow of objects to provide single flows of objects having a desired, common orient, the method comprising the steps of: delivering a bulk flow of objects; aligning the objects into single flows of objects along respective tracks; and imparting a rotational moment to each object passing along each track to rotate the object and present the object in the desired orient.

In one embodiment each track comprises first and second lateral alignment guides which act to move the objects laterally to a common track axis, and the alignment step comprises moving the objects along the alignment guides to provide a single flow of objects, one following the other.

In one embodiment the alignment guides define a progressively narrowing path, preferably tapering inwardly, which narrows along a length thereof in the flow direction.

In one embodiment each track comprises first and second lateral orienting guides which have a spacing which progressively narrows, preferably tapering inwardly, in the flow direction, and each orienting guide presents a downwardly-facing surface, under which an edge region of an object is located when moved along the orienting guides, and the orienting step comprises moving objects along the orienting guides, whereby an edge of an object becomes located under one of the orienting guides as the object is moved therealong, the other of the orienting guides, by virtue of the narrowing spacing between the orienting guides, engages an opposite edge of the object to the one edge, applying a lifting force to the opposite edge of the object and imparting a rotational moment to the object, causing the object to be oriented in the desired orient.

In one embodiment the orienting guides are inclined downwardly along a length thereof in the flow direction, such that the spacing between the downwardly-facing surfaces of the orienting guides and the base decreases progressively, whereby the one edge of the object is directed beneath the respective orienting guide and rotation of an object is promoted as the object moves along the orienting guides.

In one embodiment the orienting guides have at least an arcuate lower surface, and preferably a complete or near-complete arcuate section.

In one embodiment the orienting guides are each provided by a side wall, preferably a vertical sidewall, and a bead element projecting inwardly therefrom.

In one embodiment the bead element comprises a part-cylindrical element, preferably a hemi-cylindrical element, and preferably the bead element has a radius of about 1.5 mm.

In one embodiment the orienting guides at an outlet end thereof are located at a height above the base of the orienting part have a height above the base such that the object engages the base thereat.

In one embodiment the method further comprises the step of: transferring the aligned and oriented flows of objects downstream with the desired orient.

In one embodiment each track further comprises first and second lateral transfer guides which guide the flow of oriented objects in the desired orient.

In one embodiment the transfer guides are inclined upwardly along a length thereof in the flow direction, whereby the spacing between the transfer guides and a base increases progressively in height, thereby raising each transferred object clear of the base and providing that the transferred object is supported only by the transfer guides.

In one embodiment the transfer guides have at least an arcuate upper surface, and preferably a complete or near-complete arcuate section.

In one embodiment the transfer guides are each provided by a side wall, preferably a vertical sidewall, and a bead element projecting inwardly therefrom.

In one embodiment the bead element comprises a part-cylindrical element, preferably a hemi-cylindrical element, and preferably the bead element has a radius of about 1.5 mm.

In one embodiment the alignment and orienting steps are performed using an orienting device, preferably in the form of a tray.

In one embodiment an upstream end of the orienting device is raised slightly relative to a downstream end of the orienting device, and further comprising the step of: vibrating the orienting device to cause objects to flow along and through the orienting device.

In one embodiment the method further comprises the step of: feeding objects to the orienting device using a feed device which is connected to an upstream end of the orienting device to provide a flow of objects to the orienting device; and vibrating the feed device to cause objects to flow to the orienting device.

In one embodiment the feed device comprises a receiving part beneath an outlet, and a ramp part, preferably an arcuate ramp part, which connects the receiving part to the upstream end of the orienting device.

In one embodiment the ramp part has a progressively-decreasing radius in the flow direction, and acts to accelerate movement of object from the receiving part to the orienting device, thereby spacing the objects delivered to the orienting device.

In one embodiment the objects are unshelled nuts, preferably pistachio nuts, and the desired orient is the orient of a split in the shell, if present.

In yet another aspect the present invention provides a method of sorting objects, comprising the steps of: performing the above-described orienting method; imaging each of the flows of oriented objects, preferably both for shape and color; and separating identified objects.

In one embodiment the objects are unshelled nuts, preferably pistachio nuts, and the identified objects are objects which have a closed shell.

A preferred embodiment of the present invention will now be described hereinbelow by way of example only with reference to the accompanying drawings, in which:

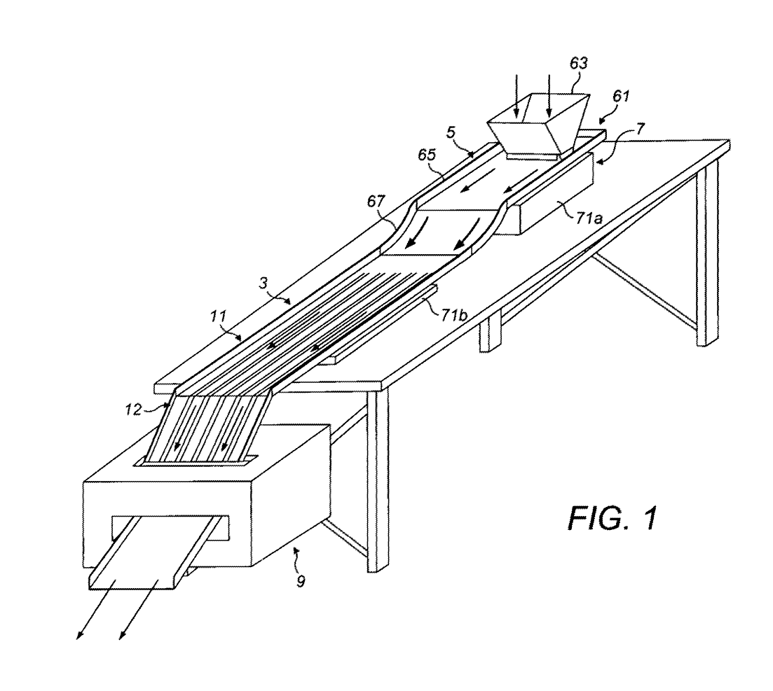

FIG. 1 illustrates a sorting apparatus in accordance with a preferred embodiment of the present invention;

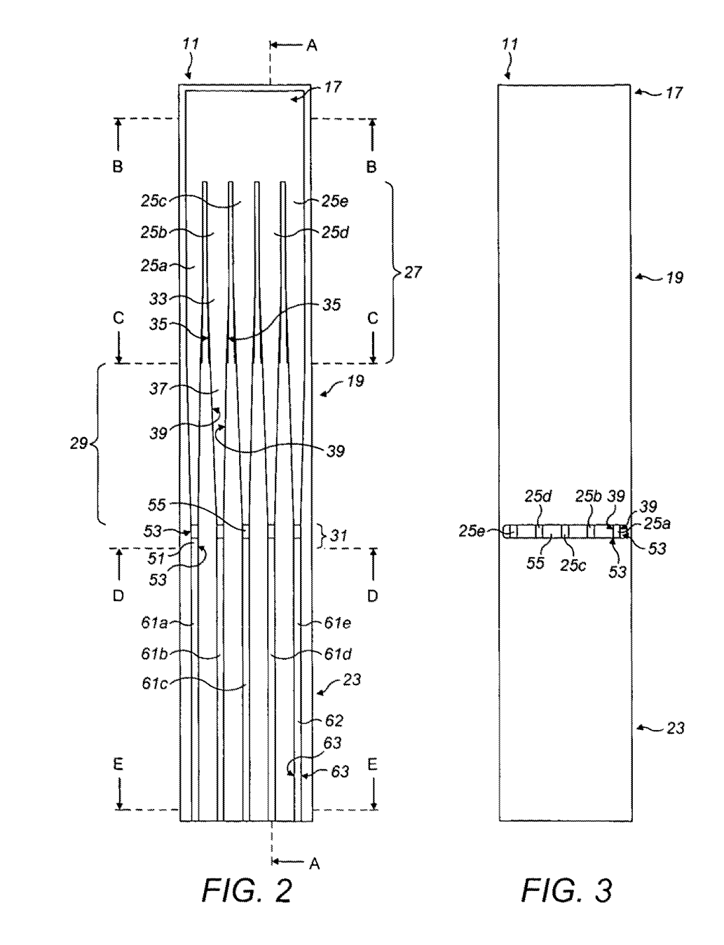

FIG. 2 illustrates a plan view of an orienting tray of the sorting apparatus of FIG. 1 in accordance with a preferred embodiment of the present invention;

FIG. 3 illustrates an underneath view of the orienting tray of FIG. 2;

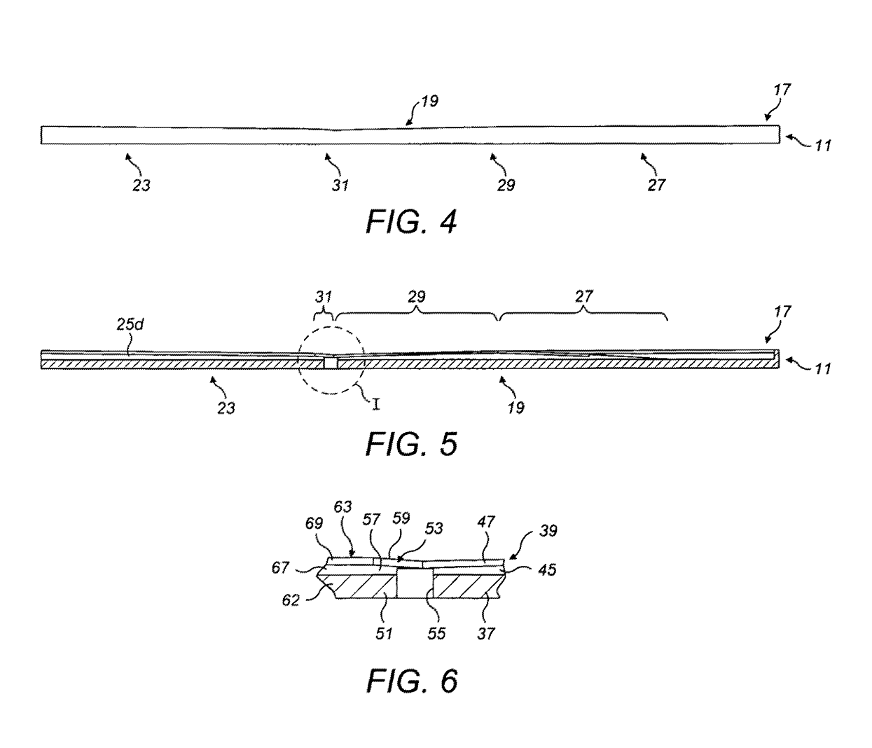

FIG. 4 illustrates a side view of the orienting tray of FIG. 2;

FIG. 5 illustrates a longitudinal sectional view (along section A-A) of the orienting tray of FIG. 2;

FIG. 6 illustrates an enlarged sectional view (region I) from the sectional view of FIG. 5;

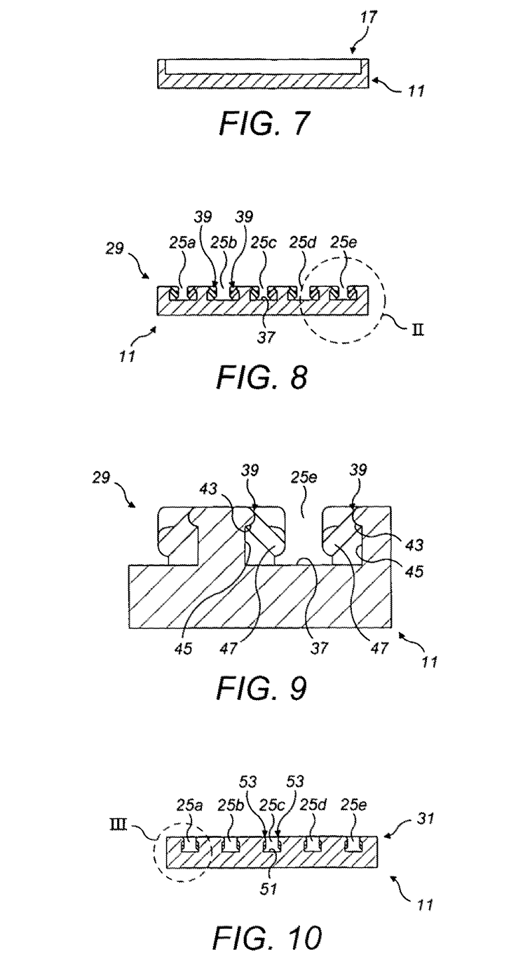

FIG. 7 illustrates a first lateral sectional view (along section B-B) of the orienting tray of FIG. 2;

FIG. 8 illustrates a second lateral sectional view (along section C-C) of the orienting tray of FIG. 2;

FIG. 9 illustrates an enlarged sectional view (region II) from the sectional view of FIG. 8;

FIG. 10 illustrates a third lateral sectional view (along section D-D) of the orienting tray of FIG. 2;

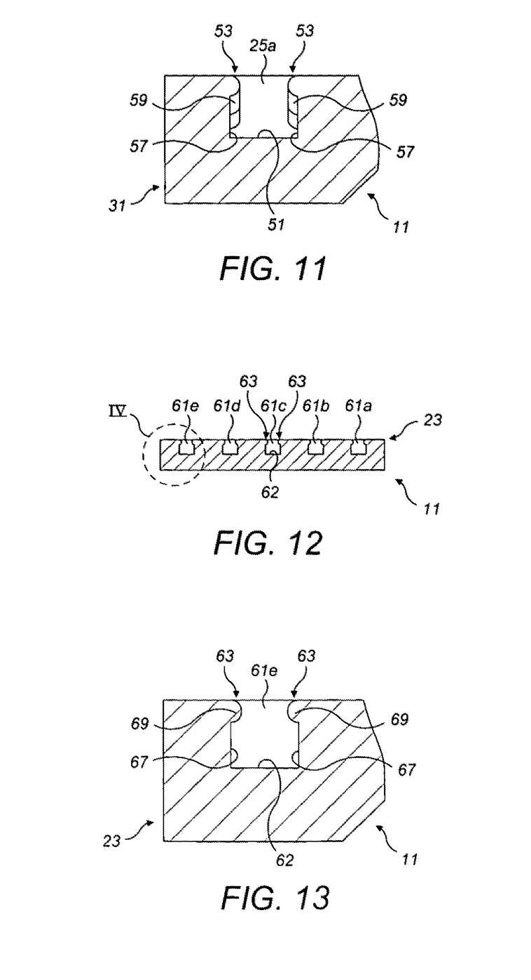

FIG. 11 illustrates an enlarged sectional view (region III) from the sectional view of FIG. 10; and

FIG. 12 illustrates a fourth lateral sectional view (along section E-E) of the orienting tray of FIG. 2;

FIG. 13 illustrates an enlarged sectional view (region IV) from the sectional view of FIG. 12;

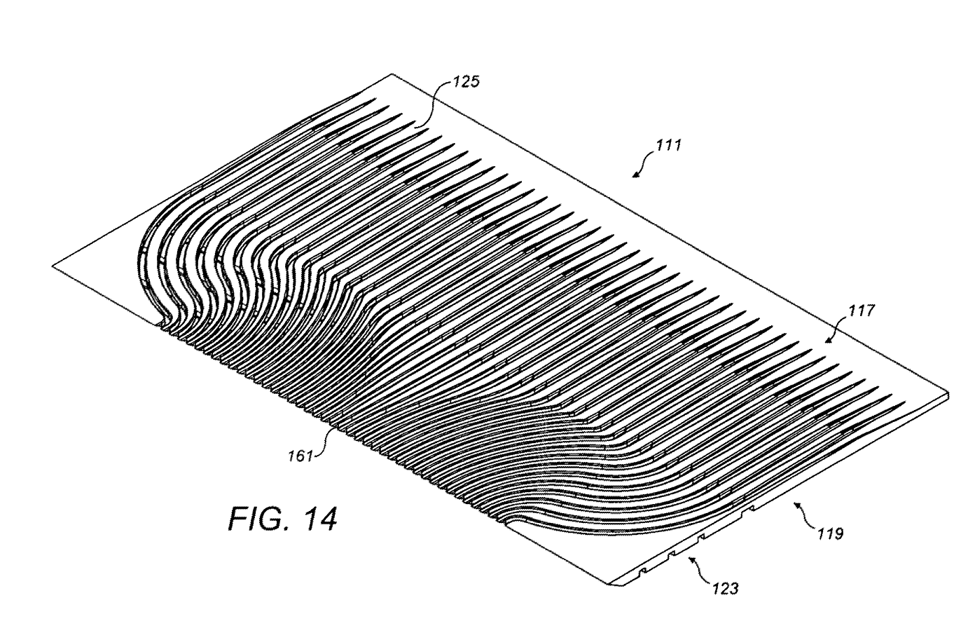

FIG. 14 illustrates a perspective view of an alternative orienting tray for use with the sorting apparatus of FIG. 1;

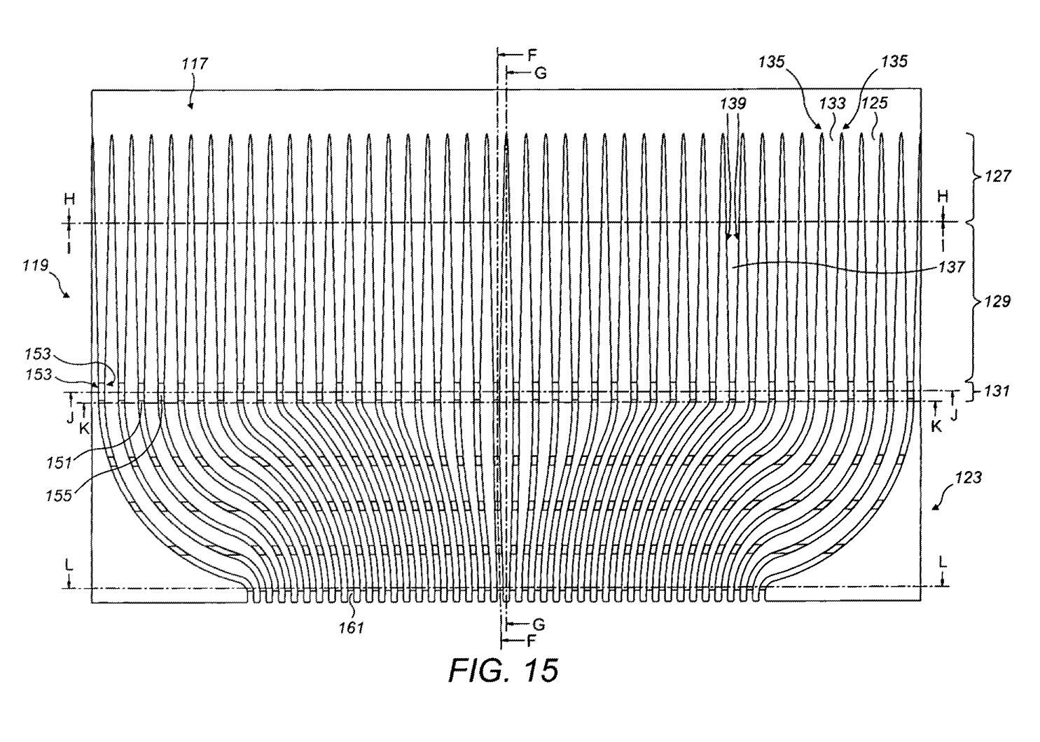

FIG. 15 illustrates a plan view of the orienting tray of FIG. 14;

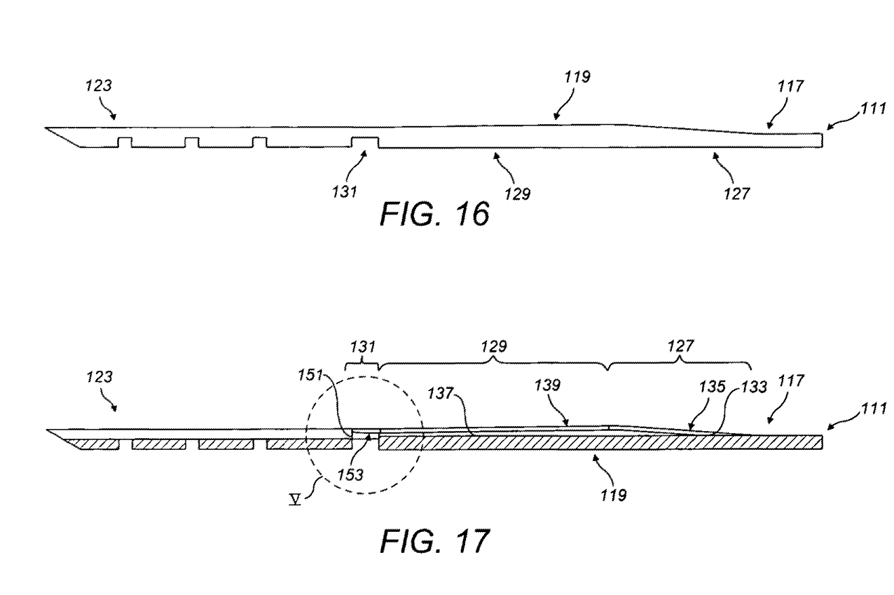

FIG. 16 illustrates a side view of the orienting tray of FIG. 14;

FIG. 17 illustrates a first longitudinal sectional view (along section F-F) of the orienting tray of FIG. 14;

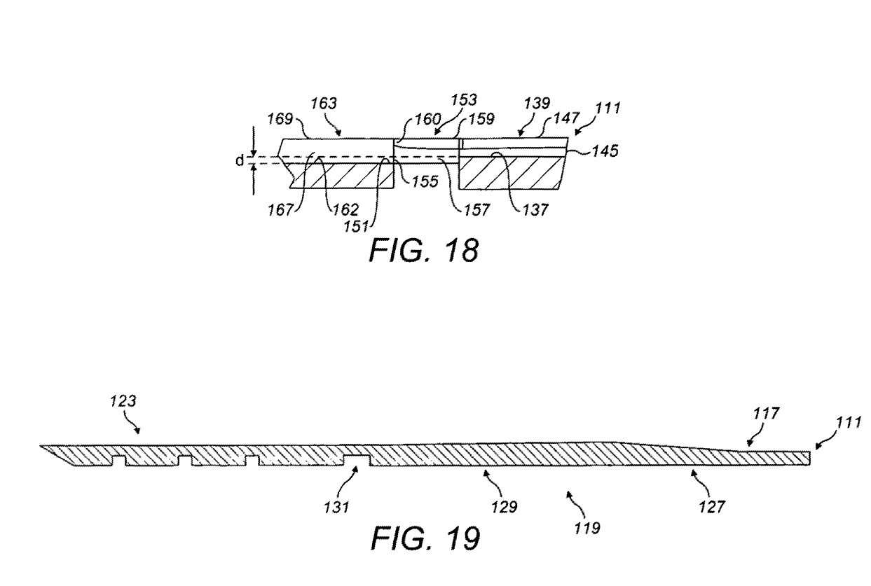

FIG. 18 illustrates an enlarged sectional view (region V) from the sectional view of FIG. 17;

FIG. 19 illustrates a second longitudinal sectional view (along section G-G) of the orienting tray of FIG. 14;

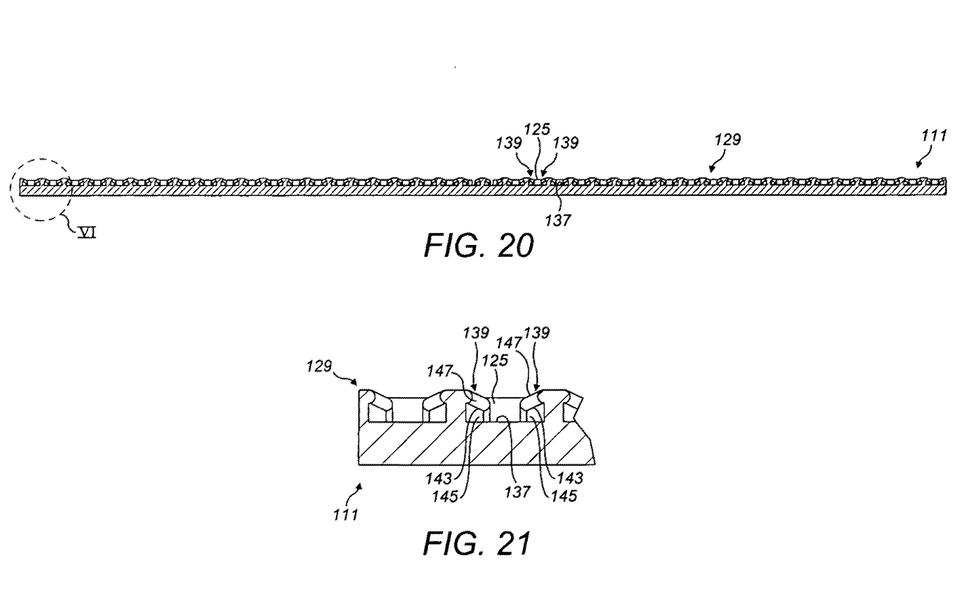

FIG. 20 illustrates a first lateral sectional view (along section H-H) of the orienting tray of FIG. 14;

FIG. 21 illustrates an enlarged sectional view (region VI) from the sectional view of FIG. 20;

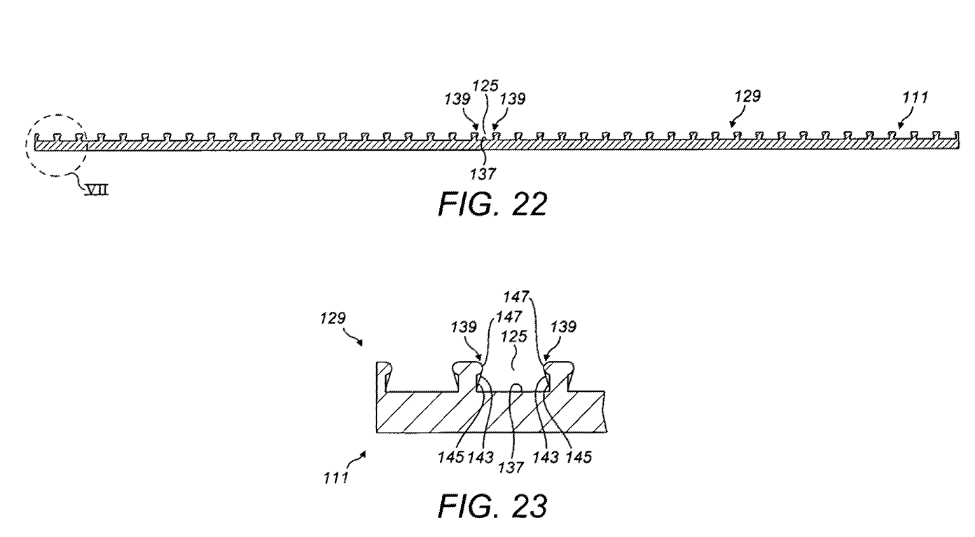

FIG. 22 illustrates a second lateral sectional view (along section I-I) of the orienting tray of FIG. 14;

FIG. 23 illustrates an enlarged sectional view (region VII) from the sectional view of FIG. 22;

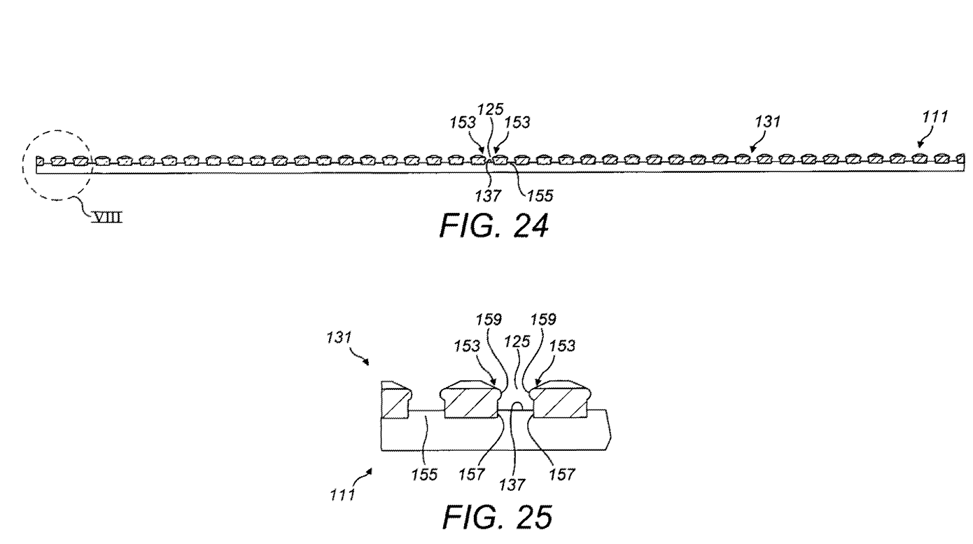

FIG. 24 illustrates a third lateral sectional view (along section J-J) of the orienting tray of FIG. 14;

FIG. 25 illustrates an enlarged sectional view (region VIII) from the sectional view of FIG. 24;

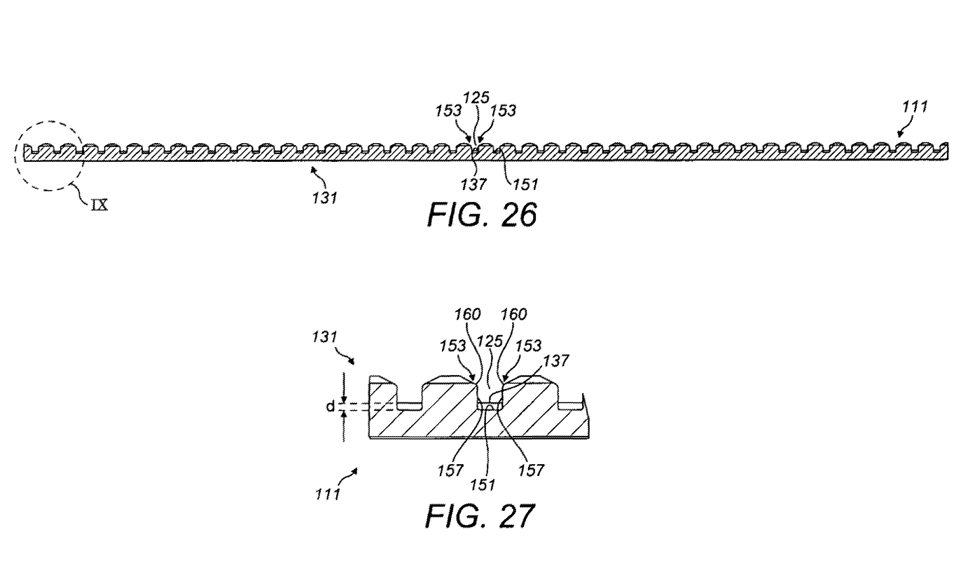

FIG. 26 illustrates a fourth lateral sectional view (along section K-K) of the orienting tray of FIG. 14;

FIG. 27 illustrates an enlarged sectional view (region IX) from the sectional view of FIG. 26;

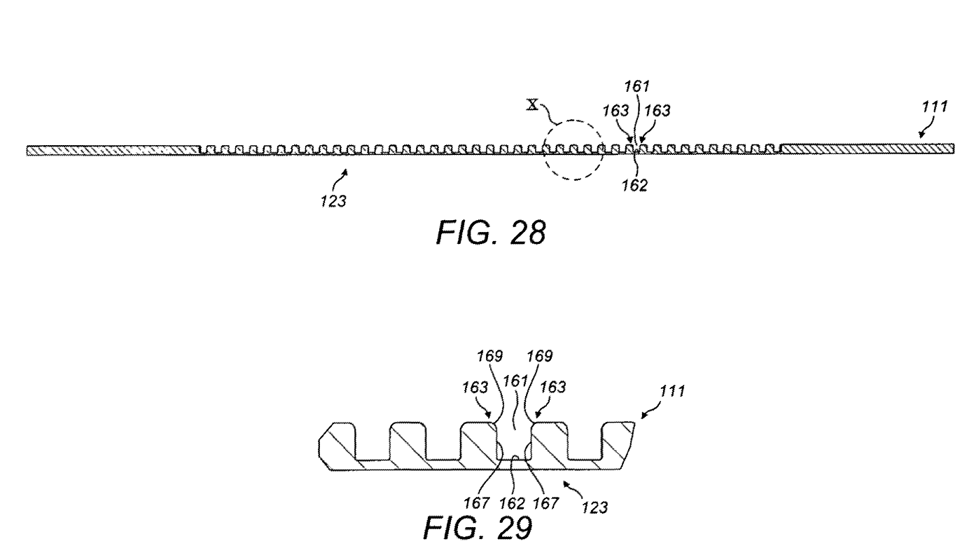

FIG. 28 illustrates a fifth lateral sectional view (along section L-L) of the orienting tray of FIG. 14;

FIG. 29 illustrates an enlarged sectional view (region X) from the sectional view of FIG. 28;

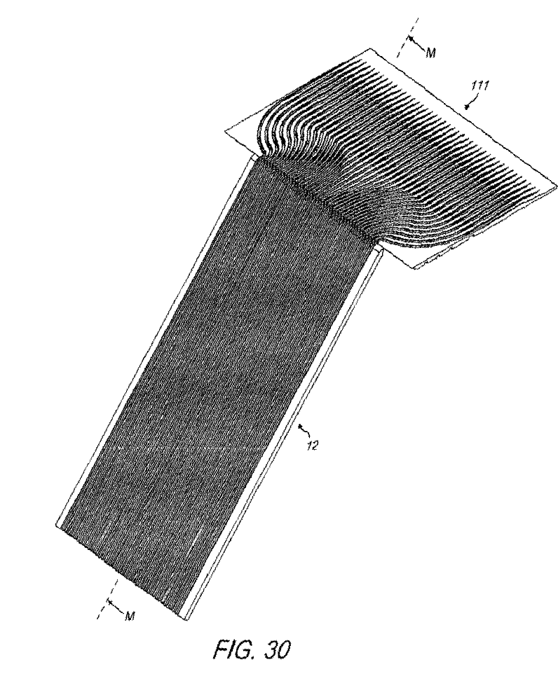

FIG. 30 illustrates a perspective view of the orienting device of FIG. 14 interfaced to the infeed chute of the separating unit of the sorting apparatus of FIG. 1;

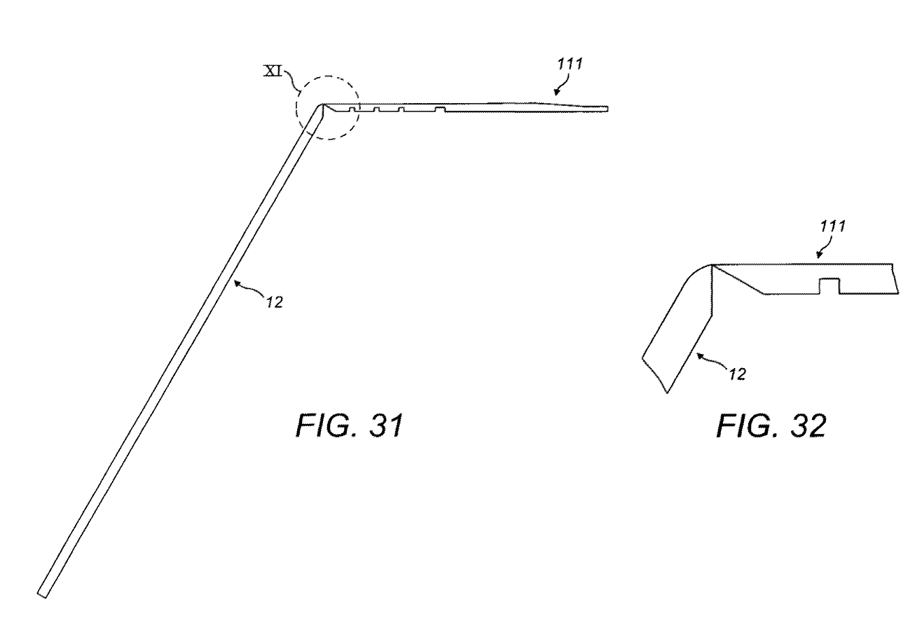

FIG. 31 illustrates a longitudinal sectional view (along section M-M) of the assembly of FIG. 30;

FIG. 32 illustrates an enlarged sectional view (region XI) from the sectional view of FIG. 31; and

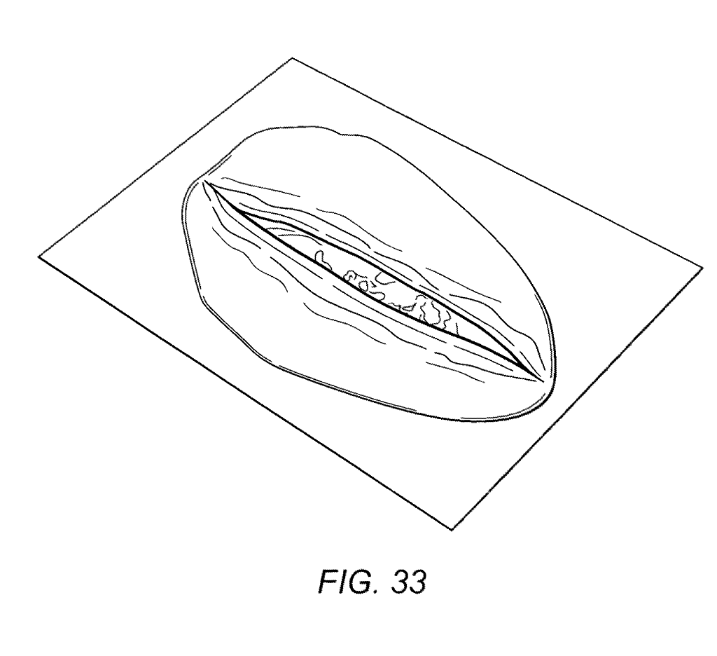

FIG. 33 illustrates a representative pistachio nut resting on a flat supporting surface.

The sorting apparatus comprises an orienting unit 3 which is operative to receive a bulk flow of nuts, in this embodiment pistachio nuts, and align and orient the nuts to provide single flows of nuts having their splits (if present) in a common orient, in this embodiment in a vertical orient, a feed unit 5, in this embodiment a hopper-based assembly, for feeding a flow of nuts to the orienting unit 3, a vibrator unit 7 for vibrating the orienting unit 3 and the feed unit 5 to transfer nuts from the feed unit 5 along and through the orienting unit 3, and a separating unit 9 for receiving the flows of nuts from the orienting unit 3 and separating nuts having no identifiable split.

In this embodiment the orienting unit 3 comprises an orienting device 11. In this embodiment the orienting device 11 is configured such that the upstream end of the orienting device 11 is raised slightly relative to the downstream end of the orienting device 11, whereby the action of the vibrator unit 7 is sufficient to cause nuts to flow along and through the orienting device 11 and to an inlet chute 12 of the separating unit 9.

The orienting device 11, in this embodiment in the form of a tray, comprises an infeed section 17 at which a bulk flow of nuts, in this embodiment pistachio nuts, having any alignment and orient, is received, an orienting section 19 in which the received nuts are provided in a plurality of separate flows and with the splits in the shells oriented, in this embodiment in a vertical orient, and an outfeed section 23 from which the aligned and oriented flows of nuts are delivered to the separating unit 9.

The alignment section 19 comprises a plurality of tracks 25, which receive a general flow of nuts from the infeed section 17, and align and orient the nuts as individual flows of oriented nuts to the outfeed section 23. In this embodiment the alignment section 19 comprises five tracks 25a-e, but could comprise any number of tracks 25.

In this embodiment each track 25 comprises a first, alignment part 27 which acts to achieve a single flow of nuts, one following the other, a second, orienting part 29, which acts to orient the nuts with the splits (if present) in the shells in a single orient, here a vertical orient, and a third, transfer part 31 which acts to transfer the aligned and oriented flows of nuts to the outfeed section 23.

In this embodiment each track 25 in the alignment part 27 comprises a base 33, which supports the received nuts, and first and second lateral guides 35, 35, which act to move the nuts laterally to a common track axis as the nuts move along the alignment part 27, and thereby provide a single flow of nuts, one following the other.

In this embodiment the guides 35, 35 define a progressively narrowing path, here tapering inwardly, which narrows along a length thereof in the flow direction, such that a single nut is passed from the alignment part 27 to the orienting part 29.

In this embodiment each track 25 in the orienting part 29 comprises a base 37, here a continuation of the base 33 of the alignment part 27, which supports the received nuts, and first and second lateral guides 39, 39, which act to confer a rotational moment to each nut and rotate the nut to present the split (if present) in a vertical orient, and thereby present a single, oriented flow of nuts, one following the other and with their splits in the vertical orient.

As particularly illustrated in FIGS. 8 and 9, in this embodiment the guides 39, 39 comprise a pair of beads, the spacing between which progressively narrows, here tapering inwardly, in the flow direction, which each present a downwardly-facing surface 43, under which an edge region of a nut is located when moved along a length of the orienting part 29. With this configuration, an edge of a pistachio nut becomes located under one of the guides 39, 39 as the nut is moved along the orienting part 29, and, by virtue of the narrowing spacing between the guides 39, 39, the other guide 39 engages an opposite edge of the nut to the one edge, applying a lifting force to the opposite edge of the nut and imparting a rotational moment to the nut, causing the nut to be oriented, in this embodiment with the split in a vertical orient.

The present inventor has recognized that certain nuts, and in particular pistachio nuts, usually have a sharper, flatter end, and that this sharper end is normally is located adjacent to or at least directed towards a supporting surface, as illustrated in FIG. 14, and further recognized that this characteristic can be utilized to trap an edge of a pistachio nut and force a rotational moment on the pistachio nut, allowing the pistachio nut to be oriented with the split in a desired orient.

In this embodiment the guides 39, 39 are inclined downwardly relative to the base 37 along a length thereof in the flow direction, such that the spacing between the downwardly-facing surfaces 43, 43 of the guides 39, 39 and the base 37 decreases progressively in height, thereby guiding the one edge of the nut beneath the respective guide 39 and promoting rotation of a nut as the nut moves along the orienting part 29.

In this embodiment the guides 39, 39 have at least an arcuate lower surface, and preferably a complete or near-complete arcuate section.

As particularly illustrated in FIGS. 8 and 9, in this embodiment the guides 39, 39 are each provided by a side wall 45, here a vertical sidewall, and a bead element 47 projecting inwardly therefrom. In a preferred embodiment the bead element 47 comprises a part-cylindrical element, here a hemi-cylindrical element. In a preferred embodiment the bead element 47 has a radius of about 1.5 mm.

In this embodiment the side walls 45 of the guides 39, 39 have a lateral spacing of about 20 mm at the inlet end of the orienting part 29, and a lateral spacing of about 10 mm at the outlet end of the orienting part 29.

In this embodiment the bead elements 47 of the guides 39, 39 are centred at a height of about 8.5 mm above the base 37 at the inlet end of the orienting part 29, and are centred at a height of about 3.5 mm above the base 37 at the outlet end of the orienting part 29.

In this embodiment each track 25 in the transfer part 31 comprises a base 51, here a continuation of the base 37 of the orienting part 29, and first and second lateral guides 53, 53, which act to guide the flow of oriented nuts from the orienting part 29, in this embodiment one following the other and with their splits in the vertical orient, to the outfeed section 23.

In this embodiment the base 51 includes at least one aperture 55 therein, here a single elongate aperture, which allows any shell halves which may become detached from the nuts to fall from the orienting tray 11.

In an alternative embodiment the transfer part 31 could omit the base 51, and instead have an open lower surface.

As particularly illustrated in FIGS. 6, 10 and 11 in this embodiment the guides 53, 53 comprise a pair of beads, which are continuations of the guides 39, 39 of the orienting part 29.

In this embodiment the guides 53, 53 are inclined upwardly along a length thereof in the flow direction, such that the spacing between the guides 53, 53 and the base 51 increases progressively in height, thereby raising each transferred nut clear of the base 51, such that the nut is supported only by the guides 53, 53.

In this embodiment the guides 53, 53 have at least an arcuate upper surface, and preferably a complete or near-complete arcuate section.

As particularly illustrated in FIGS. 10 and 11, in this embodiment the guides 53, 53 are each provided by a side wall 57, here a vertical sidewall, and a bead element 59 projecting inwardly therefrom. In a preferred embodiment the bead element 59 comprises a part-cylindrical element, here a hemi-cylindrical element. In a preferred embodiment the bead element 59 has a radius of about 1.5 mm.

In this embodiment the side walls 57 of the guides 53, 53 have a lateral spacing of about 10 mm.

In this embodiment the bead elements 59 of the guides 53, 53 are centred at a height of about 3.5 mm above the base 51 at the inlet end of the transfer part 31, and are centred at a height of about 8.5 mm above the base 51 at the outlet end of the transfer part 31.

The outfeed section 23 comprises a plurality of tracks 61, which are counterpart to the tracks 25 of the orienting section 21 and each receive a single flow of oriented nuts from the orienting section 21 and transfer the flows of oriented nuts to the separating unit 9. In this embodiment the outfeed section 23 comprises five tracks 61a-e, but could comprise any number of tracks 61 counterpart in number to the tracks 25 of the orienting section 21.

In this embodiment each track 61 in the outfeed section 23 comprises a base 62, here a continuation of the base 51 of the transfer part 31 of the orienting section 21, and first and second lateral guides 63, 63, which act to guide the flow of oriented nuts from the transfer part 31 of the orienting section 21, in this embodiment one following the other and with their splits in the vertical orient, to the separating unit 9.

In an alternative embodiment the outfeed section 23 could omit the base 62, and instead have an open lower surface.

As particularly illustrated in FIGS. 12 and 13, in this embodiment the guides 63, 63 comprise a pair of beads, which are continuations of the guides 53, 53 of the transfer part 31 of the orienting section 21.

In this embodiment the guides 63, 63 extend linearly at a fixed height from the base 62, such that each nut is supported only by the guides 63, 63.

In this embodiment the guides 63, 63 have at least an arcuate upper surface, and preferably a complete or near-complete arcuate section.

As particularly illustrated in FIGS. 12 and 13, in this embodiment the guides 63, 63 are each provided by a side wall 67, here a vertical sidewall, and a bead element 69 projecting inwardly therefrom. In a preferred embodiment the bead element 69 comprises a part-cylindrical element, here a hemi-cylindrical element. In a preferred embodiment the bead element 69 has a radius of about 1.5 mm.

In this embodiment the side walls 67 of the guides 63, 63 have a lateral spacing of about 10 mm.

In this embodiment the bead elements 69 of the guides 63, 63 are centred at a height of about 8.5 mm above the base 62.

In this embodiment the orienting tray 11 has a length of less than 1 m, which compares to the sorting drum of a pin sorter, which has a length of typically 10 m.

In this embodiment the orienting tray 11 is provided with a smooth surface finish, at least in respect of those surface features which contact the nuts, and especially the guides 35, 35, 39, 39, 53, 53, 63, 63. These surface features can be anodised, polished, coated or plated.

In this embodiment the feed unit 5 comprises a feed tray 61 which is connected to the upstream end of the orienting tray 11 to provide a flow of nuts to the orienting tray 11, and a hopper 63 for maintaining a supply of nuts to the feed tray 61.

In this embodiment the feed tray 61 comprises a flat, receiving part 65 beneath the outlet of the hopper 63, and an arcuate ramp part 67 which connects the receiving part 65 to the upstream end of the orienting tray 11.

In this embodiment the ramp part 67 has a progressively-decreasing radius in the flow direction, and acts to accelerate the movement of nuts from the flat part 65 to the infeed section 17 of the orienting tray 11, thereby spacing the nuts delivered to the infeed section 17 of the orienting tray 11 and facilitating alignment of the nuts in the individual tracks 25a-e of the orienting tray 11.

In this embodiment the vibration unit 7 comprises at least one vibrator 71, here a plurality of vibrators 71a, b, which are operative to vibrate the feed tray 61 of the feed unit 5 and the orienting tray 11 of the orienting unit 3, such as to impart a vibration on nuts when supported thereon and transfer the same along and through the orienting unit 3.

In this embodiment the vibrator 71 vibrates the orienting tray 11 at about 50 Hz, but other frequencies could be employed, for example, a higher frequency, typically at or above 100 Hz.

In this embodiment the separating unit 9 comprises an imaging device which images the flows of nuts delivered from the orienting tray 11, here both for shape and color, and determines whether the individual nuts are open or closed, and a deflector device, here an array of ejector nozzles, which are operated under the control of a controller to deflect the nuts which are identified as closed into a separate flow from the flow of desired open nuts.

Preliminary results have indicated that an efficiency of at least 90% can be achieved by the sorting apparatus of the present invention. This compares to an efficiency of 75% which can be achieved by the existing pin sorters, which, as discussed above, are expensive to purchase and maintain and also extremely large in size.

FIGS. 14 to 29 illustrate an alternative orienting device 111 for use in the sorting apparatus of the above-described embodiment.

The orienting device 111, in this embodiment in the form of a tray, comprises an infeed section 117 at which a bulk flow of nuts, in this embodiment pistachio nuts, having any alignment and orient, is received, an orienting section 119 in which the received nuts are provided in a plurality of separate flows and with the splits in the shells oriented, in this embodiment in a vertical orient, and an outfeed section 123 from which the aligned and oriented flows of nuts are delivered to the separating unit 9.

The alignment section 119 comprises a plurality of tracks 125, which receive a general flow of nuts from the infeed section 117, and align and orient the nuts as individual flows of oriented nuts to the outfeed section 123. In this embodiment the alignment section 119 comprises forty-two tracks 125, but could comprise any number of tracks 125.

In this embodiment each track 125 comprises a first, alignment part 127 which acts to achieve a single flow of nuts, one following the other, a second, orienting part 129, which acts to orient the nuts with the splits (if present) in the shells in a single orient, here a vertical orient, and a third, transfer part 131 which acts to transfer the aligned and oriented flows of nuts to the outfeed section 123.

In this embodiment each track 125 in the alignment part 127 comprises a base 133, which supports the received nuts, and first and second lateral guides 135, 135, which act to move the nuts laterally to a common track axis as the nuts move along the alignment part 127, and thereby provide a single flow of nuts, one following the other.

In this embodiment the guides 135, 135 define a progressively narrowing path, here tapering inwardly, which narrows along a length thereof in the flow direction, such that a single nut is passed from the alignment part 127 to the orienting part 129.

In this embodiment each track 125 in the orienting part 129 comprises a base 137, here a continuation of the base 133 of the alignment part 127, which supports the received nuts, and first and second lateral guides 139, 139, which act to confer a rotational moment to each nut and rotate the nut to present the split (if present) in a vertical orient, and thereby present a single, oriented flow of nuts, one following the other and with their splits in the vertical orient.

As particularly illustrated in FIGS. 20 to 23, in this embodiment the guides 139, 139 comprise a pair of beads, the spacing between which progressively narrows, here tapering inwardly, in the flow direction, which each present a downwardly-facing surface 143, under which an edge region of a nut is located when moved along a length of the orienting part 129. With this configuration, an edge of a pistachio nut becomes located under one of the guides 139, 139 as the nut is moved along the orienting part 129, and, by virtue of the narrowing spacing between the guides 139, 139, the other guide 139 engages an opposite edge of the nut to the one edge, applying a lifting force to the opposite edge of the nut and imparting a rotational moment to the nut, causing the nut to be oriented, in this embodiment with the split in a vertical orient.

The present inventor has recognized that certain nuts, and in particular pistachio nuts, usually have a sharper, flatter end, and that this sharper end is normally is located adjacent to or at least directed towards a supporting surface, as illustrated in FIG. 33, and further recognized that this characteristic can be utilized to trap an edge of a pistachio nut and force a rotational moment on the pistachio nut, allowing the pistachio nut to be oriented with the split in a desired orient.

In this embodiment the guides 139, 139 are inclined downwardly relative to the base 137 along a length thereof in the flow direction, such that the spacing between the downwardly-facing surfaces 143, 143 of the guides 139, 139 and the base 137 decreases progressively in height, thereby guiding the one edge of the nut beneath the respective guide 139 and promoting rotation of a nut as the nut moves along the orienting part 129.

In this embodiment the guides 139, 139 have at least an arcuate lower surface, and preferably a complete or near-complete arcuate section.

As particularly illustrated in FIGS. 20 to 23, in this embodiment the guides 139, 139 are each provided by a side wall 145, here a vertical sidewall, and a bead element 147 projecting inwardly therefrom. In a preferred embodiment the bead element 147 comprises a part-cylindrical element, here a hemi-cylindrical element. In a preferred embodiment the bead element 147 has a radius of about 1.5 mm.

In this embodiment the side walls 145 of the guides 139, 139 have a lateral spacing of about 20 mm at the inlet end of the orienting part 129, and a lateral spacing of about 10 mm at the outlet end of the orienting part 129.

In this embodiment the bead elements 147 of the guides 139, 139 are centred at a height of about 8.5 mm above the base 137 at the inlet end of the orienting part 129, and are centred at a height of about 3.5 mm above the base 137 at the outlet end of the orienting part 129.

In this embodiment each track 125 in the transfer part 131 comprises a base 151, here stepped downwardly by a distance (d) relative to the base 137 of the orienting part 129, and first and second lateral guides 153, 153, which act to guide the flow of oriented nuts from the orienting part 129, in this embodiment one following the other and with their splits in the vertical orient, to the outfeed section 123.

In this embodiment the base 151 includes at least one aperture 155 therein, here defined by a single slot to the underside of the base 151, which allows any shell halves which may become detached from the nuts to fall from the orienting tray 111.

In an alternative embodiment the transfer part 131 could omit the base 151, and instead have an open lower surface.

As particularly illustrated in FIGS. 18 and 24 to 27, in this embodiment the guides 153, 153 comprise a pair of beads, as continuations of the guides 139, 139 of the orienting part 129, which transition into a pair of radiuses having no undercut.

In this embodiment the spacing between the guides 153, 153 and the base 151 is such that each transferred nut is clear of the base 151, whereby the nut is supported only by the guides 53, 53.

In this embodiment the guides 153, 153 have at least an arcuate upper surface, and preferably a complete or near-complete arcuate section.

As particularly illustrated in FIGS. 24 to 27, in this embodiment the guides 153, 153 are each provided by a side wall 157, here a vertical sidewall, a bead element 159 projecting inwardly therefrom at an upstream end, and a radius element 160 at a downstream end, with the bead element 159 transitioning into the radius element 160 progressively along the length of the transfer part 131. In a preferred embodiment the bead element 159 comprises a part-cylindrical element, here a hemi-cylindrical element. In a preferred embodiment the bead element 159 and the radius element 160 have a radius of about 1.5 mm.

In this embodiment the side walls 157 of the guides 153, 153 have a lateral spacing of about 10 mm.

In this embodiment the bead elements 159 and the radius elements 160 of the guides 153, 153 are centred at a height of about 8.5 mm above the base 151.

The outfeed section 123 comprises a plurality of tracks 161, which are counterpart to the tracks 125 of the orienting section 121 and each receive a single flow of oriented nuts from the orienting section 121 and transfer the flows of oriented nuts to the separating unit 9. In this embodiment the outfeed section 123 comprises forty two tracks 161, but could comprise any number of tracks 161 counterpart in number to the tracks 125 of the orienting section 121.

In this embodiment the tracks 161 are configured such that the spacing, here the mean spacing, of the tracks 161 is less at an outlet end of the outfeed section 123 than an inlet end of the outfeed section 123. In this embodiment all of the outer tracks 161 are inwardly directed, here with an arcuate path.

In this embodiment the tracks 161 at the outlet end of the outfeed section 123 have a mean spacing about two-thirds that of the mean spacing of the tracks 161 at the inlet end of the outfeed section 123. In a preferred embodiment the tracks 161 at the outlet end of the outfeed section 123 have a mean spacing of less than three-quarters of the mean spacing of the tracks 161 at the inlet end of the outfeed section 123, and preferably less than two-thirds of the mean spacing of the tracks 161 at the inlet end of the outfeed section 123.

In this embodiment each track 161 in the outfeed section 123 comprises a base 162, here a continuation of the base 151 of the transfer part 131 of the orienting section 121, and first and second lateral guides 163, 163, which act to guide the flow of oriented nuts from the transfer part 131 of the orienting section 121, in this embodiment one following the other and with their splits in the vertical orient, to the separating unit 9.

In an alternative embodiment the outfeed section 123 could omit the base 162, and instead have an open lower surface.

As particularly illustrated in FIGS. 28 and 29, in this embodiment the guides 163, 163 comprise a pair of beads, which are continuations of the guides 153, 153 of the transfer part 131 of the orienting section 121.

In this embodiment the guides 163, 163 extend linearly at a fixed height from the base 162, such that each nut is supported only by the guides 163, 163.

In this embodiment the guides 163, 163 have at least an arcuate upper surface, and preferably a complete or near-complete arcuate section.

As particularly illustrated in FIGS. 28 and 29, in this embodiment the guides 163, 163 are each provided by a side wall 167, here a vertical sidewall, and a radius element 169 at an upper edge thereof. In a preferred embodiment the radius element 169 has a radius of about 1.5 mm.

In this embodiment the side walls 167 of the guides 163, 163 have a lateral spacing of about 10 mm.

In this embodiment the radius elements 169 of the guides 163, 163 are centred at a height of about 8.5 mm above the base 162.

In this embodiment the orienting tray 111 has a length of less than 1 m, which compares to the sorting drum of a pin sorter, which has a length of typically 10 m.

In this embodiment the orienting tray 111 is provided with a smooth surface finish, at least in respect of those surface features which contact the nuts, and especially the guides 135, 135, 139, 139, 153, 153, 163, 163. These surface features can be anodised, polished, coated or plated.

FIGS. 30 to 32 illustrate the orienting device 111 interfaced to an infeed chute 12 of the separating unit 9 of the sorting apparatus of FIG. 1.

Finally, it will be understood that the present invention has been described in its preferred embodiment and can be modified in many different ways without departing from the scope of the invention as defined by the appended claims.

For example, although in this embodiment the orienting tray 11, 111 has been fabricated from an extruded and/or machined metal piece, the orienting tray 11, 111 could alternatively be formed from wire elements. Also, the orienting tray 11, 111 could be formed from other than metal, such as plastics or composite materials.

Furthermore, although the present invention has been described particularly in relation to the sorting of pistachio nuts, the present invention has application to other nuts, such as cardamom seeds, and also other foodstuffs or bulk objects which require orienting in the present manner for sorting.

1. An orienting device for receiving a bulk flow of objects and aligning and orienting the objects to provide single flows of objects having a desired, common orient, the device comprising:
an infeed section to which a flow of objects is delivered; and
an orienting section in which the objects are provided in a plurality of separate flows and with the desired orient;
wherein the orienting section comprises a plurality of tracks, which receive a flow of objects from the infeed section, and align and orient the objects as individual flows of oriented objects, each track comprising an orienting part, which comprises a base and first and second lateral orienting guides which act to confer a rotational moment to each object passing therealong and rotate the object to present the object in the desired orient, the orienting guides having a spacing which progressively narrows, preferably tapering inwardly, in the flow direction, and each orienting guide presenting a downwardly-facing surface, under which an edge region of an object is located when moved along a length of the orienting part, such that, when an edge of an object becomes located under one of the orienting guides as the object is moved therealong, the other of the orienting guides, by virtue of the narrowing spacing between the orienting guides, engages an opposite edge of the object to the one edge, applying a lifting force to the opposite edge of the object and imparting a rotational moment to the object, causing the object to be oriented in the desired orient.

2. The device of claim 1, wherein the orienting section further comprises an alignment part, upstream of the orienting part, which acts to achieve a single flow of objects, optionally each track in the alignment part comprises a base, which supports the objects passing therethrough, and first and second lateral alignment guides which act to move the objects laterally to a common track axis as the objects move along the alignment part, and thereby provide a single flow of objects, one following the other, optionally the alignment guides define a progressively narrowing path, preferably tapering inwardly, which narrows along a length thereof in the flow direction, such that a single object is passed from the alignment part to the orienting part.

3. (canceled)

4. (canceled)

5. (canceled)

6. The device of claim 1, wherein the orienting guides are inclined downwardly relative to the base along a length thereof in the flow direction, such that the spacing between the downwardly-facing surfaces of the orienting guides and the base decreases progressively, thereby guiding the one edge of the object beneath the respective orienting guide and promoting rotation of an object as the object moves along the orienting part.

7. The device of claim 1, wherein the orienting guides have at least an arcuate lower surface, and preferably a complete or near-complete arcuate section, optionally the orienting guides are each provided by a side wall, preferably a vertical sidewall, and a bead element projecting inwardly therefrom, optionally the bead element comprises a part-cylindrical element, preferably a hemi-cylindrical element, and preferably the bead element has a radius of about 1.5 mm.

8. (canceled)

9. (canceled)

10. The device of claim 1, wherein the orienting guides at the outlet end of the orienting part have a height above the base of orienting part which provides for the object to engage the base of the orienting part thereat.

11. The device of claim 1, wherein the orienting section further comprises a transfer part, downstream of the orienting part, which acts to transfer the aligned and oriented flows of objects from the orienting part, optionally each track in the transfer part comprises first and second lateral transfer guides, which act to guide the flow of oriented objects from the orienting part in the desired orient, optionally each track in the transfer part further comprises a base which includes at least one aperture therein, which allows any object parts which may become detached to fall from the orienting device, optionally (I) the transfer guides are inclined upwardly along a length thereof in the flow direction, such that the spacing between the transfer guides and the base increases progressively in height, thereby raising each transferred object clear of the base and providing that the transferred object is supported only by the transfer guides or (II) the spacing between the transfer guides and the base is such that the transferred objects are supported only by the transfer guides, optionally the transfer guides have at least an arcuate upper surface, and preferably a complete or near-complete arcuate section, optionally (I) the transfer guides are each provided by a side wall, preferably a vertical sidewall, and a bead element projecting inwardly therefrom, preferably the bead element comprises a part-cylindrical element, preferably a hemi-cylindrical element, and preferably the bead element has a radius of about 1.5 mm, or (II) the guides are each provided by a side wall, preferably a vertical sidewall, a bead element projecting inwardly therefrom at an upstream end, and a radius element at a downstream end, with the bead element transitioning into the radius element progressively along a length of the transfer part, preferably the bead element and the radius element comprise a part-cylindrical element, and preferably the bead element and the radius element have a radius of about 1.5 mm.

12. (canceled)

13. (canceled)

14. (canceled)

15. (canceled)

16. (canceled)

17. (canceled)

18. (canceled)

19. (canceled)

20. (canceled)

21. The device of claim 1, further comprising:
an outfeed section, downstream of the orienting section, from which the aligned and oriented flows from the orienting section are delivered, wherein the outfeed section comprises a plurality of tracks, optionally the tracks in the outfeed section are configured such that the mean spacing of the tracks is less at a downstream end of the outfeed section than at an upstream end of the outfeed section, optionally the tracks at the downstream end of the outfeed section have a mean spacing of less than three-quarters of the mean spacing of the tracks at the upstream end of the outfeed section, and preferably less than two-thirds of the mean spacing of the tracks at the upstream end of the outfeed section, optionally all of the outer tracks are inwardly directed, preferably with an arcuate path.

22. (canceled)

23. (canceled)

24. (canceled)

25. The device of claim 1, wherein an upstream end of the orienting device is raised slightly relative to a downstream end of the orienting device, whereby a vibration action is sufficient to cause objects to flow along and through the orienting device.

26. The device of claim 1, where provided in the form of a tray.

27. The device of claim 1, wherein the objects are unshelled nuts, preferably pistachio nuts, and the desired orient is the orient of a split in the shell, if present.

28. A orienting apparatus for receiving objects in bulk and aligning and orienting the objects to provide single flows of objects having a desired, common orient, the apparatus comprising:
an orienting unit comprising the orienting device of claim 1; and
a feed unit for feeding objects to the orienting unit.

29. The apparatus of claim 28, wherein the feed unit comprises a feed device which is connected to an upstream end of the orienting device to provide a flow of objects to the orienting device, the feed device comprising a receiving part beneath an outlet, and a ramp part, preferably an arcuate ramp part, which connects the receiving part to the upstream end of the orienting device, optionally the ramp part has a progressively-decreasing radius in the flow direction, and acts to accelerate movement of object from the receiving part to the infeed section of the orienting device, thereby spacing the objects delivered to the infeed section of the orienting device.

30. (canceled)

31. The apparatus of claim 29, further comprising:
a vibration unit which is operative to vibrate the feed device of the feed unit and the orienting device of the orienting unit, such as to impart a vibration on objects when supported thereon and transfer the same along and through the orienting device.

32. A sorting system for sorting objects, comprising:
the orienting apparatus of claim 28; and
a separation unit for imaging the flows of objects delivered from the orienting device, preferably both for shape and color, and separating identified objects.

33. (canceled)

34. A method of aligning and orienting objects from a bulk flow of objects to provide single flows of objects having a desired, common orient, the method comprising the steps of:
delivering a bulk flow of objects;
aligning the objects into single flows of objects along respective tracks, wherein each track comprises first and second lateral orienting guides which have a spacing which progressively narrows, preferably tapering inwardly, in the flow direction, and each orienting guide presents a downwardly-facing surface, under which an edge region of an object is located when moved along the orienting guides; and
imparting a rotational moment to each object passing along each track to rotate the object and present the object in the desired orient, wherein, as an object moves along the orienting guides, an edge of the object becomes located under one of the orienting guides, and the other of the orienting guides, by virtue of the narrowing spacing between the orienting guides, engages an opposite edge of the object to the one edge, applying a lifting force to the opposite edge of the object and imparting a rotational moment to the object, causing the object to be oriented in the desired orient.

35. The method of claim 34, wherein each track comprises first and second lateral alignment guides which act to move the objects laterally to a common track axis, and the alignment step comprises moving the objects along the alignment guides to provide a single flow of objects, one following the other, optionally the alignment guides define a progressively narrowing path, preferably tapering inwardly, which narrows along a length thereof in the flow direction.

36. (canceled)

37. (canceled)

38. The method of claim 34, wherein the orienting guides are inclined downwardly along a length thereof in the flow direction, such that the spacing between the downwardly-facing surfaces of the orienting guides and the base decreases progressively, whereby the one edge of the object is directed beneath the respective orienting guide and rotation of an object is promoted as the object moves along the orienting guides, optionally the orienting guides have at least an arcuate lower surface, and preferably a complete or near-complete arcuate section, optionally the orienting guides are each provided by a side wall, preferably a vertical sidewall, and a bead element projecting inwardly therefrom, optionally the bead element comprises a part-cylindrical element, preferably a hemi-cylindrical element, and preferably the bead element has a radius of about 1.5 mm, optionally the orienting guides at an outlet end thereof have a height above the base such that the object engages the base thereat.

39. (canceled)

40. (canceled)

41. (canceled)

42. (canceled)

43. The method of claim 34, further comprising the step of:
transferring the aligned and oriented flows of objects downstream with the desired orient, optionally each track further comprises first and second lateral transfer guides which guide the flow of oriented objects in the desired orient, optionally (I) the transfer guides are inclined upwardly along a length thereof in the flow direction, whereby the spacing between the transfer guides and a base increases progressively in height, thereby raising each transferred object clear of the base and providing that the transferred object is supported only by the transfer guides or (II) the spacing between the transfer guides and a base therebelow is such that the transferred objects are supported only by the transfer guides, optionally the transfer guides have at least an arcuate upper surface, and preferably a complete or near-complete arcuate section, optionally (I) the transfer guides are each provided by a side wall, preferably a vertical sidewall, and a bead element projecting inwardly therefrom, preferably the bead element comprises a part-cylindrical element, preferably a hemi-cylindrical element, and preferably the bead element has a radius of about 1.5 mm, or (II) the guides are each provided by a side wall, preferably a vertical sidewall, a bead element projecting inwardly therefrom at an upstream end, and a radius element at a downstream end, with the bead element transitioning into the radius element progressively along a length of the transfer part, preferably the bead element and the radius element comprise a part-cylindrical element, and preferably the bead element and the radius element have a radius of about 1.5 mm.

44. (canceled)

45. (canceled)

46. (canceled)

47. (canceled)

48. (canceled)

49. (canceled)

50. (canceled)

51. (canceled)

52. The method of claim 34, wherein the alignment and orienting steps are performed using an orienting device, preferably in the form of a tray.

53. The method of claim 52, wherein an upstream end of the orienting device is raised slightly relative to a downstream end of the orienting device, and further comprising the step of:
vibrating the orienting device to cause objects to flow along and through the orienting device.

54. The method of claim 53, further comprising the step of:
feeding objects to the orienting device using a feed device which is connected to an upstream end of the orienting device to provide a flow of objects to the orienting device, optionally the feed device comprises a receiving part beneath an outlet, and a ramp part, preferably an arcuate ramp part, which connects the receiving part to the upstream end of the orienting device, optionally the ramp part has a progressively-decreasing radius in the flow direction, and acts to accelerate movement of object from the receiving part to the orienting device, thereby spacing the objects delivered to the orienting device; and
vibrating the feed device to cause objects to flow to the orienting device.

55. (canceled)

56. (canceled)

57. The method of claim 34, wherein the objects are unshelled nuts, preferably pistachio nuts, and the desired orient is the orient of a split in the shell, if present.

58. A method of sorting objects, comprising the steps of:
performing the orienting method of claim 34;
imaging each of the flows of oriented objects, preferably both for shape and color; and
separating identified objects.

59. (canceled)

60. (canceled)

61. (canceled)

62. (canceled)

63. (canceled)

64. (canceled)
